(19) United States
(12) Patent Application Publication
(10) Pub. No.: US 2024/0279880 A1
(43) Pub. Date: Aug. 22, 2024

(54) Traction Improving Mesh Device and Method of Use

(71) Applicant: Joe Clark, Buffalo, NY (US)

(72) Inventor: Joe Clark, Buffalo, NY (US)

(21) Appl. No.: 18/514,347

(22) Filed: Nov. 20, 2023

Related U.S. Application Data
(60) Provisional application No. 63/446,507, filed on Feb. 17, 2023.

(51) Int. Cl. E01C 9/08; E01C 11/24

(52) U.S. Cl. CPC E01C 9/083; E01C 11/24

(57) ABSTRACT

A traction device for enhancing vehicular traction, aiding in the extraction of vehicles stuck in challenging terrains such as mud, snow, or ice. The device has a rectangular mesh configuration, comprised of longitudinal chains and lateral chains. The device further includes a plurality of parallel lateral chains extending across the longitudinal chains for providing support to the device. A plurality of pegs and pins are used for securing the device to a terrain in which the vehicle is stuck. A handle of the device touches the front tire and another handle touches the rear tire. The traction device has a length from about 90% to about 100% of the vehicle's wheelbase, and the mesh width, ranges from 6 to 24 inches, to accommodate various tire widths.

### CROSS-REFERENCE TO RELATED APPLICATION

The present application claims priority to, and the benefit of, U.S. Provisional Application No. 63/446,507, which was filed on Feb. 17, 2023, and is incorporated herein by reference in its entirety.

### FIELD OF THE INVENTION

The present invention generally relates to the field of devices for improving traction for a tire of a vehicle. More specifically, the present invention relates to a novel vehicular wheel traction device intended to enhance vehicular traction, aiding in the extraction of vehicles stuck in challenging terrains such as mud, snow, or ice. The device includes a plurality of interconnected chains designed to form a mesh and is placed between a front tire and a corresponding rear tire of a vehicle. The device is secured to the terrain and provides improved traction by allowing the tires to spin along a portion of the mesh. Accordingly, the present disclosure makes specific reference thereto. Nonetheless, it is to be appreciated that aspects of the present invention are also equally applicable to other like applications, devices, and methods of manufacture.

### BACKGROUND

By way of background, vehicles are commonly stuck in snow or mud because the snow or mud acts as a lubricant, reducing the traction between the tires and the ground. Such a situation often happens during off-road traveling and in inclement weather. Traction is the force that prevents the tire from slipping and is created by the friction between the tire tread and the road/ground surface. When a motorist applies torque to take the vehicle out of the snow or mud, the tires spin constantly without any movement due to lack of traction and because the torque is greater than the traction force. This not only causes damage to the tire but also causes frustration to the motorist.

For pulling out the stuck vehicle, people may need to call for a tow truck which is time-consuming and expensive. Often, help from other motorists is required, however, the availability of the other motorists is not always readily available. Use of all-season tires or winter tires to improve traction is also ineffective and reducing tire pressure is also often difficult and ineffective. Rocking the vehicle back and forth by shifting between forward and reverse gears to compact the mud or snow under the tires and improve traction is time-consuming, ineffective, and requires expertise. Pulling or pushing the vehicle out of snow or mud is laborious, difficult, and time-consuming. People desire a simple-to-use and effective device for improving traction to free a vehicle from mud, snow, ice, or any other terrain.

Therefore, there exists a long-felt need in the art for a traction device to help vehicles get unstuck from mud, snow, ice, and other terrain. Additionally, there is a long-felt need in the art for a traction improving device that enables a user to free a stuck vehicle without help from other users and/or from other vehicles. Moreover, there is a long-felt need in the art for a specialized vehicular traction device that can be placed underneath tires for easy use for freeing a stuck vehicle that has lost traction. Further, there is a long-felt need in the art for a traction device that can be used without using any specialized tools and is effective in a variety of terrains. Furthermore, there is a long-felt need in the art for a vehicle tires traction improving device that enables the vehicle to slowly accelerate over the chains and mesh. Also, there is a long-felt need in the art for a traction device that can be secured to the ground underneath the vehicle for preventing displacement thereof during application of torque on the wheels. Finally, there is a long-felt need in the art for an improved traction device that eliminates the need to call a tow truck or ask other motorists for assistance (i.e., winch capable) when trying to move a stuck vehicle.

The subject matter disclosed and claimed herein, in one embodiment thereof, comprises a vehicle wheel traction device for improving traction force for a vehicle stuck in mud, snow, ice, or any other terrain. The traction device features a rectangular chain mesh. The mesh is formed of two longitudinal chains and a pair of lateral chains. The lateral chains extend transversely between the ends of the longitudinal chains. A plurality of parallel chains is disposed across the longitudinal chains to provide support to the mesh. Each chain is made of a plurality of interconnected steel links, the links can be permanently interconnected or detachably connected. A plurality of pins is disposed along the longitudinal chains for removably securing the traction device to the ground for preventing unintentional movement of the device. A pair of handles are attached to the lateral chains for easy handling and control, wherein the length of the traction device is substantially equal to 90% of the wheelbase of a vehicle. A first handle contacts a rear area proximal to the contact patch of the front tire and a second handle contacts a front area proximal to the contact patch of the rear tire for providing improved traction.

In this manner, the traction device of the present invention accomplishes all of the foregoing objectives and provides users with a traction device that is designed to help vehicles get unstuck from mud, snow, ice, and other terrain. The device is easy to use and the vehicle can easily accelerate over the device. The device eliminates the need to call a tow truck or ask other motorists for assistance when trying to move a stuck vehicle and can be used with any terrain.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle wheel traction device. The traction device is used for improving traction force for a wheel to free the vehicle from snow, mud, ice, or any other similar terrain. The traction device further comprising a rectangular chain mesh. The mesh is formed of two longitudinal chains and a pair of lateral chains. The lateral chains extend transversely between the longitudinal chains. A plurality of parallel chains is disposed across the longitudinal chains to provide support to the mesh. Each chain is made of a plurality of interconnected steel links, the links can be permanently interconnected or detachably connected. A plurality of pins are disposed along the longitudinal chains for removably securing the traction device to the ground. A pair of handles are attached to the lateral chains for easy handling and control, wherein the length of the traction device is substantially equal to about 90% of the wheelbase length of a vehicle.

In a further embodiment of the present invention, a chain traction mesh grid device is disclosed. The device is used for freeing vehicles that are stuck in mud, snow, ice, or sand. The device includes a chain mesh which is from 6 inches to 10 inches wide and stretches from the rear tire to the front tire of a vehicle. A handle is positioned on both ends of the device for controlling movement, and a plurality of pins are disposed along the chain mesh. The device is made of steel links such that one handle is positioned to touch the rear of the contact patch of the front tire to provide improved traction to prevent the tire from slipping and losing traction when attempting to free the vehicle.

In yet another embodiment, the length of the traction device between the handles is substantially from about 90% to about 100% of the wheelbase length of a vehicle.

In yet another embodiment, the mesh includes a plurality of parallel chains wherein, the distance between each pair of the parallel chains is from about 80% to about 120% of a contact patch length of a tire of a vehicle for allowing the tire to be easily positioned between two parallel chains.

In yet another embodiment, a traction device designed to be placed between a front tire and a corresponding rear tire of a vehicle to free the vehicle from a stuck terrain position is disclosed. The traction device includes a mesh of a plurality of chains, each chain is formed using interconnected links. The mesh includes a plurality of pins for securing the mesh to the terrain on which the vehicle is stuck. The mesh is placed underneath the vehicle and on the terrain with a distal end of the mesh touching the rear side of the front tire and an opposite distal end of the mesh touching the front of the rear tire. In use, when the torque is provided to the vehicle, the mesh functions as a barrier between the front and rear tires and the terrain to improve traction force to free the vehicle from the stuck position.

In yet another aspect, a method for providing improved traction for vehicles that require temporary improved traction for freeing when being stuck in a terrain environment is described. The method includes positioning a mesh of chain between a front tire and the corresponding rear tire of the vehicle, one distal end touches the back of the front tire, an opposite distal end touches the front of the rear tire, securing the mesh on the terrain using a plurality of pins, applying torque to the vehicle, providing improved traction force by the mesh device to both the front tire and the rear tire, and freeing the vehicle from the stuck position.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the vehicular tire traction device of the present invention in accordance with the disclosed structure;

FIG. 2 illustrates an enlarged view of the pin used in the traction device for securing the traction into the ground in accordance with the disclosed structure;

FIG. 3 illustrates a perspective view showing the traction device of the present invention positioned between the front tire and rear tire of a stuck vehicle for improving traction force in accordance with the disclosed structure; and

FIG. 4 illustrates a perspective view showing the vehicle stuck in FIG. 3 in an unstuck position using the traction device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a traction device to help vehicles get unstuck from mud, snow, ice, and other terrain. Additionally, there is a long-felt need in the art for a traction improving device that enables a user to free a stuck vehicle without help of other users and/or other vehicles. Moreover, there is a long-felt need in the art for a specialized vehicular traction device that can be placed underneath tires for easy use for freeing a stuck vehicle that has lost traction. Further, there is a long-felt need in the art for a traction device that can be used without using any specialized tools and is effective in a variety of terrains. Furthermore, there is a long-felt need in the art for a vehicle tire(s) traction improving device that enables the vehicle to slowly accelerate over the chains and mesh. Also, there is a long-felt need in the art for a traction device that can be secured to the ground underneath the vehicle for preventing displacement thereof during application of torque on the wheels. Finally, there is a long-felt need in the art for an improved traction device that eliminates the need to call a tow truck or ask other motorists for assistance when trying to move a stuck vehicle.

The present invention, in one exemplary embodiment, is a method for providing improved traction for vehicles that require temporary improved traction for freeing after being stuck in a terrain environment. The method includes positioning a mesh of chain between a front tire and the corresponding rear tire of the vehicle, one distal end touches the back of the front tire, an opposite distal end touches the front of the rear tire, securing the mesh on the terrain using a plurality of pins, applying torque to the vehicle, providing improved traction force by the mesh device to both the front tire and the rear tire, and freeing the vehicle from the stuck position. It is to be appreciated that while freeing a stuck vehicle, the vehicle may rock rearwards and thus subsequent forward motion will engage the front wheel with the mesh of chain followed by the rear wheel engaging the mesh of chain.

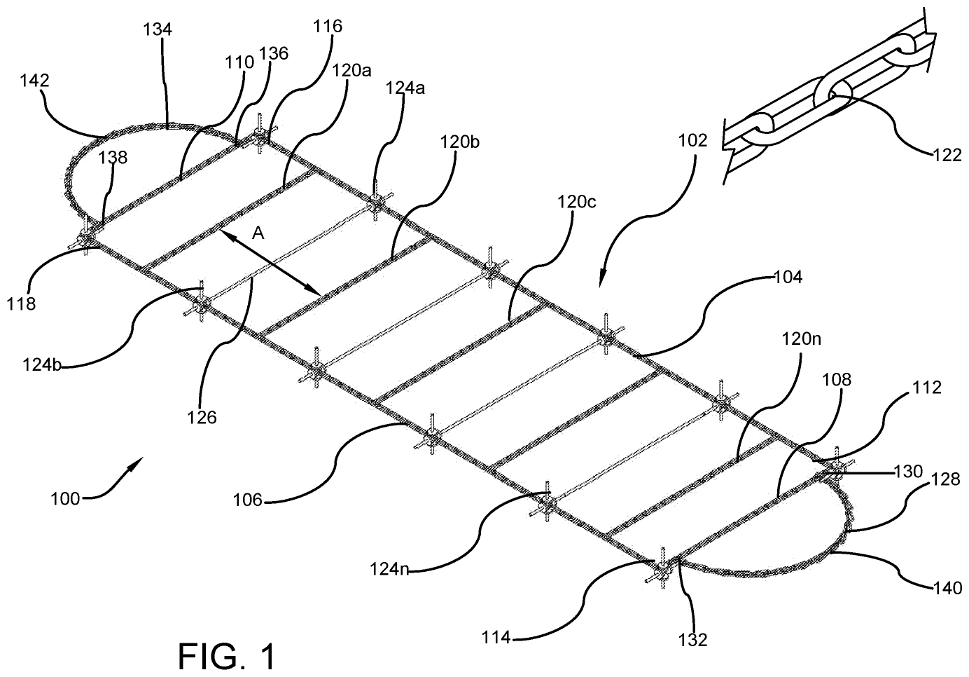

Referring initially to the drawings, FIG. 1 illustrates a perspective view of the vehicular tire traction device of the present invention in accordance with the disclosed structure. The vehicular wheel traction device 100 is designed to improve traction for vehicular wheels to help vehicles get unstuck from mud, snow, ice, and other terrain. More specifically, the traction device 100 includes a rectangular mesh 102 formed of two longitudinal chains 104, 106 and a pair of lateral chains 108, 110. The first lateral chain 108 extends between the first ends 112, 114 of the chains 104, 106, respectively. The second lateral chain 110 extends between the second ends 116, 118 of the chains 104, 106 respectively. A plurality of parallel chains 120a-n are disposed across the longitudinal chains 104, 106 to form the mesh 102. The distance (Arrow A, FIG. 1) between each pair of the parallel chains (such as 120a, 120b) is substantially from about 80% to about 120% of a contact patch length of a tire of a vehicle.

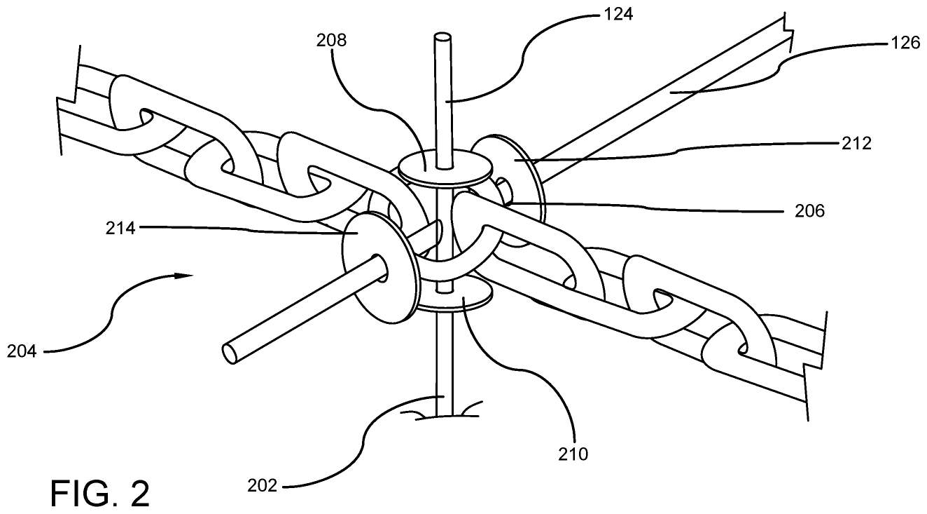

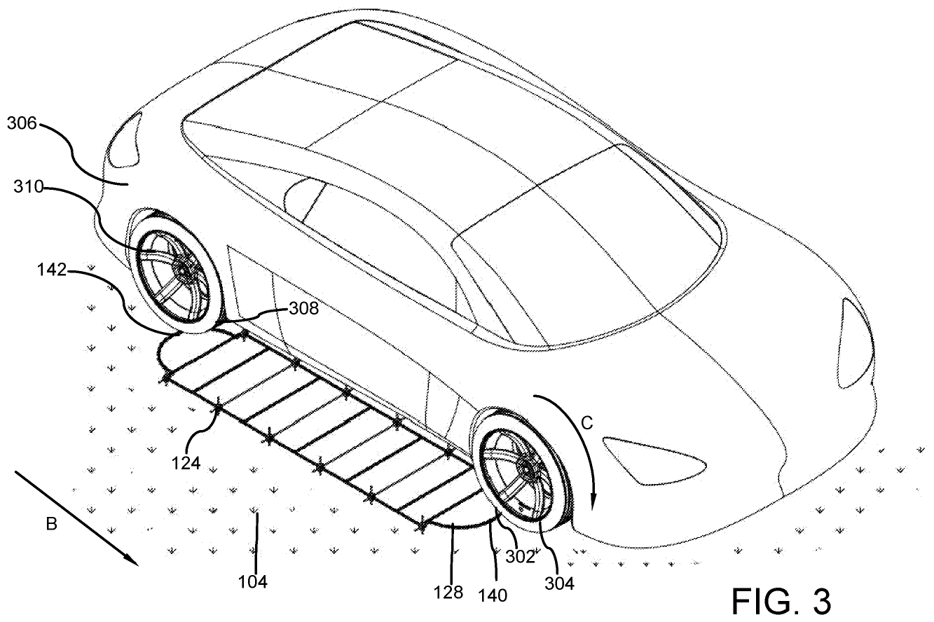

All the chains included in the traction device 100 are made of steel, non-corrosive iron, or any other similar material. Each chain is made of a plurality of interconnected steel links 122. The links 122 can be permanently interconnected to each other such as through welding or can be designed to be detachably connected to each other. For removably securing the traction device 100 to the ground during use of the device 100 as described in FIGS. 2 and 3, a plurality of pins 124a-n (hereinafter referred to as 124) are included in the traction device 100. The pins are aligned in pairs wherein one pin such as 124a of a pair is disposed in a first longitudinal chain 104 and an opposite pin 124b is disposed symmetrically in the second longitudinal chain 106. A peg or rod 126 extends between the symmetrically aligned pins 124a, 124b. Similar rods are positioned between each opposite pair of opposite pins. Each pin is designed to be secured into the ground as illustrated in FIG. 3 for secure placement under a vehicle which is required to be moved from a stuck position.

For easy handling and controlling movement of the device 100, a first handle 128 is attached to the first lateral chain 108. The first handle 128 is preferably semi-circular and is integrated at opposite ends 130, 132 to the first lateral chain 108. A second handle 134 is attached to the second lateral chain 110. The second handle 134 is symmetrical to the first handle 128 and is integrated at opposite ends 136, 138 to the second lateral chain 110. The handles 128, 134 can be of any geometric shape as per the design requirements and user requirements.

The length of the traction device 100 extending between the distal end 140 of the first handle 128 and the distal end 142 of the second handle 134 is substantially equal to about 90% to 100% of the wheelbase of a vehicle. The width of the mesh 102 is in the range from about 6 inches to about 24 inches to be used with tires of different widths. The traction device 100 is placed between the rear of the front wheel and front of the rear wheel of a vehicle providing improved traction and grip to free a stuck vehicle.

FIG. 2 illustrates an enlarged view of the pin used in the traction device for securing the traction into the ground in accordance with the disclosed structure. The pointed end 202 of the pin 124 is secured to the ground 204 such that the pin 124 provides support and stability to the traction device 100. The pin 124 is inserted through a link 206 of the longitudinal chain 104 and therefore, prevents lateral or rotational movement of the chain 104. A pair of support members 208, 210 prevents the vertical movement of the chain 104 and enables easy holding of the pin 124.

The peg or rod 126 passes through the pin 124 and includes another pair of the supporting members 212, 214 for preventing horizontal movement of the chain 104. The rod 126 is made of lightweight metal or steel and extends between the longitudinal chains 104, 106.

FIG. 3 illustrates a perspective view showing the traction device 100 of the present invention positioned between the front tire and the rear tire of a stuck vehicle for improving traction force in accordance with the disclosed structure. As illustrated, the traction device 100 is placed on the ground 204 and is secured using the plurality of pins 124. The device 100 is placed such that the distal end 140 of the first handle 128 touches the rear 302 of the front tire 304 of the vehicle 306 and the distal end 142 of the second handle 134 touches the front 308 of the rear tire 310.

The device 100 is positioned in an elongated position (Arrow B, FIG. 3) between the front tire 304 and the rear tire 310. For providing improved traction force between the other set of the front wheel and the rear wheel, the traction device 100 can also be placed between the other set of wheels. In use, when the driver of the vehicle 306 provides a torque such as by providing an acceleration using the accelerator of the vehicle 306, initially a short counterclockwise movement followed by a clockwise movement (Arrow C, FIG. 3) of the front tire 304 enables the front tire 304 to slide across the handle 128. The handle 128 made of steel links provides improved grip and traction by functioning as a barrier between the tire 304 and the ground 204. This helps the tire 304 to easily move forward without much acceleration and time.

It will be appreciated by a person skilled in the art that the traction device 100 can easily be positioned underneath the vehicle 306 and secured to the ground 204 easily without using any additional tools. Further, a user can easily place the device 100 without requiring any repositioning of a still vehicle.

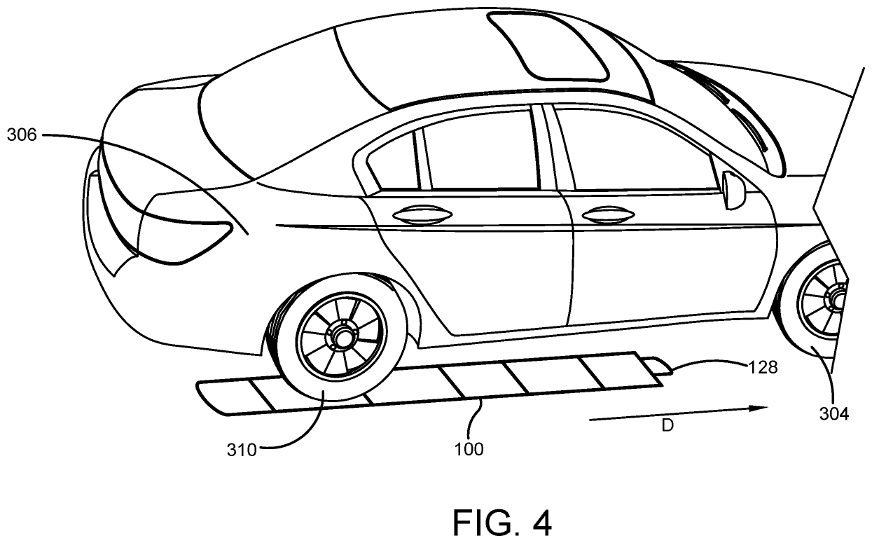

FIG. 4 illustrates a perspective view showing the vehicle 306 in an unstuck position using the traction device of the present invention in accordance with the disclosed structure. When the torque is applied by the motorist, the front tire 304 abuts and moves against the handle 128 for a forward movement (Arrow D, FIG. 4). Also, as the traction device 100 is secured to the ground 204, therefore, movement of the rear tire 310 over the mesh 102 does not create any movement in the device 100 and thus, does not create any obstruction in the forward movement of the rear tire 310. The tires traction improving device 100 can be removed from the ground 204 after use and can be stored in the vehicle for easy transportation and reuse.

The vehicle tires traction device 100 can come in different sizes as per the wheelbase of different vehicles and can be made of different materials. Further, the device 100 is anti-skid on any type of terrain and provides improved traction along with the treads of a wheel. Furthermore, the device 100 is durable and is not damaged when a vehicle passes through the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tires traction improving device”, “traction device”, “vehicle tires traction device”, “device”, and “vehicular tires traction device” are interchangeable and refer to the vehicle tires traction device 100 of the present invention.

Notwithstanding the foregoing, the vehicle tires traction device 100 of the present invention can be of any suitable size and configuration as is known in the art without affecting the overall concept of the invention, provided that it accomplishes the above-stated objectives. One of ordinary skill in the art will appreciate that the vehicle tires traction device 100 as shown in the FIGS. is for illustrative purposes only, and that many other sizes and shapes of the vehicle tires traction device 100 are well within the scope of the present disclosure. Although the dimensions of the vehicle tires traction device 100 are important design parameters for user convenience, the vehicle tires traction device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wheel traction device for assisting a stuck vehicle, the wheel traction device comprising:
a traction device having a mesh formed of two longitudinal chains, a pair of lateral chains, and a plurality of parallel chains;
wherein a first lateral chain extends between front ends of said two longitudinal chains;
wherein a second lateral chain extends between rear ends of said two longitudinal chains;
wherein said plurality of parallel chains are disposed and spaced across said two longitudinal chains; and
further wherein a distance between each of said pair of parallel chains is from 80% to 120% of a contact patch length of a tire of the vehicle.

2. The wheel traction device of claim 1, wherein said pair of lateral chains include a material selected from the group consisting of a steel and a non-corrosive iron.

3. The wheel traction device of claim 2, wherein said plurality of parallel chains include a material selected from the group consisting of a steel and a non-corrosive iron.

4. The wheel traction device of claim 3, wherein said pair of lateral chains having a plurality of interconnected links.

5. The wheel traction device of claim 4, wherein said plurality of parallel chains having a plurality of interconnected links.

6. The wheel traction device of claim 5 further comprising a first plurality of pins connected to said first longitudinal chain and a second plurality of pins connected to said second longitudinal chain for anchoring said traction device to the ground, wherein a pair of opposing pins from said first longitudinal chain and said second longitudinal chain having a rod connected therebetween.

7. The wheel traction device of claim 6, wherein said mesh is rectilinear in shape.

8. The wheel traction device of claim 7, wherein said traction device having at least a first handle connected proximal to a front end of said first longitudinal chain and proximal to a front end of said second longitudinal chain.

9. The wheel traction device of claim 8, wherein said at least first handle having a plurality of interconnected links.

10. The wheel traction device of claim 9, wherein said traction device having a second handle connected proximal to a rear end of said first longitudinal chain and proximal to a rear end of said second longitudinal chain.

11. The wheel traction device of claim 10, wherein said second handle having a plurality of interconnected links.

12. The traction device of claim 11, wherein said traction device having a length extending from a distal end of said first handle to a distal end of said second handle, and further wherein said length is from 90% to 100% of a wheelbase of the vehicle.

13. The traction device of claim 12, wherein said traction device having a width from 6 inches to 24 inches.

14. A wheel traction device for assisting a stuck vehicle, the wheel traction device comprising:
a traction device having a mesh formed of two longitudinal chains, a pair of lateral chains, and a plurality of parallel chains;
wherein a first lateral chain extends between front ends of said two longitudinal chains;
wherein a second lateral chain extends between rear ends of said two longitudinal chains;
wherein said plurality of parallel chains are disposed and spaced across said two longitudinal chains;
wherein said pair of lateral chains include a material selected from the group consisting of a steel and a non-corrosive iron;
wherein said plurality of parallel chains include a material selected from the group consisting of a steel and a non-corrosive iron;
wherein said pair of lateral chains having a plurality of interconnected links; and
further wherein said plurality of parallel chains having a plurality of interconnected links.

15. The wheel traction device of claim 14, wherein a distance between each of said pair of parallel chains is from 80% to 120% of a contact patch length of a tire of the vehicle.

16. The wheel traction device of claim 14 further comprising a first plurality of pins connected to said first longitudinal chain and a second plurality of pins connected to said second longitudinal chain for anchoring said traction device to the ground, wherein a pair of opposing pins from said first longitudinal chain and said second longitudinal chain having a rod connected therebetween.

17. The wheel traction device of claim 14, wherein said traction device having a length, and further wherein said length is from 90% to 100% of a wheelbase of the vehicle.

18. The wheel traction device of claim 14, wherein said traction device having a width from 6 inches to 24 inches.

19. A method for freeing a stuck vehicle from the terrain, the method comprising the steps of:
providing a traction device having a mesh formed of two longitudinal chains and a plurality of parallel lateral chains extending orthogonally between said two longitudinal chains, wherein said plurality of parallel lateral chains are disposed and spaced across said two longitudinal chains;
forming said two longitudinal chains from a material selected from the group consisting of a steel and a non-corrosive iron, wherein said two longitudinal chains having a plurality of interconnected links;
forming said plurality of parallel lateral chains from a material selected from the group consisting of a steel and a non-corrosive iron, wherein said plurality of parallel lateral chains having a plurality of interconnected links;
placing a front end of said traction device proximal to a rear edge of a front tire of the vehicle and placing a rear end of said traction device proximal to a front edge of a rear tire of the vehicle; and
driving the vehicle forward.

20. The method for freeing a stuck vehicle of claim 19 further comprising a step of anchoring at least one of said two longitudinal chains to the terrain with a pin extending through at least one of said plurality of interconnected links.
